(19) United States
(12) Patent Application Publication
(10) Pub. No.: US 2007/0276081 A1
(43) Pub. Date: Nov. 29, 2007

(54) High modulus thermoplastic compositions

(76) Inventor: Shengmei Yuan, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/804,377

(22) Filed: May 18, 2007

Related U.S. Application Data
(60) Provisional application No. 60/818,574, filed on Jul. 5, 2006.
(60) Provisional application No. 60/802,608, filed on May 23, 2006.

(51) Int. Cl. C08K 3/40

(52) U.S. Cl. 524/494; 524/496

(57) ABSTRACT

Thermoplastic compositions which contain more than 50 weight percent of a combination of carbon and glass fibers in specified ratios have a good combination of high tensile modulus and toughness. They are useful as molded or extruded parts wherein high stiffness and strength, combined with toughness, are needed.

### CROSS REFERENCE TO RELATED APPLICATIONS

This application claims the benefit of U.S. Provisional Application No. 60/802,608, filed May 23, 2006 and U.S. Provisional Application No. 60/818,574, filed Jul. 5, 2006.

### FIELD OF THE INVENTION

Relatively tough high modulus thermoplastic compositions result when the thermoplastics contain a combination of glass and carbon fibers in a specified ratio range, and the total amount of such fibers is more than 50 weight percent of the total composition.

### TECHNICAL BACKGROUND

Thermoplastics are important items of commerce. In many instances they are used in parts where one or more minimum physical properties are required, and the physical properties of these polymers may be modified by adding to them ingredients such as fillers and/or reinforcing agents (these terms sometimes overlap) which can modify their properties. For instance relatively high modulus fibers such as glass or carbon fibers may be added to such polymers to increase their modulus and/or tensile strength, but oftentimes this results in a decrease in other desirable properties such as toughness. Therefore such compositions are often compromises between various desired properties. Generally speaking the more high modulus fibrous material one adds to the thermoplastic the higher the modulus and the lower the toughness. Addition of fibers may also result in other deleterious results such as an increase in melt viscosity and other measures of processability.

Metals often have a superior combinations of properties, especially a combination of modulus and toughness that is difficult to match in thermoplastics. For instance one can add much glass fiber to a thermoplastic but still not achieve a 25 GPa tensile modulus, while one can add much carbon fiber (which usually has a higher modulus than glass fiber) to a thermoplastic and achieve a tensile modulus over 25 GPa, but the resulting composition with carbon fiber is quite brittle. Thus thermoplastic compositions which have a combination of high tensile modulus (>25 GPa) and relatively good toughness are desired.

U.S. Pat. No. 5,371,132 describes a composition comprising a partially aromatic polyamide and 5-70% by weight of at least one inorganic filler including glass fiber and carbon fiber. There is no discussion or examples of compositions containing >50 weight percent fiber and a combination of glass and carbon fibers.

U.S. Pat. Nos. 3,981,504, 4,970,255, 6,689,835 and 6,911,169 describe compositions of various thermoplastics which have high loadings of fibrous fillers, and/or (possible) combinations of glass and carbon fibers. None of these discuss or have examples of the particular compositions described herein.

### SUMMARY OF THE INVENTION

This invention concerns a composition, comprising,
(a) a thermoplastic; and
(b) a filler component consisting essentially of chopped glass fiber and chopped carbon fiber wherein said filler component is more than 50 weight percent of the total weight of said composition, and a weight ratio of said glass fiber to said carbon fiber is about 13:1.0 to about 1.0:1.0.

Also included in the invention are a process for forming a shaped article, and a shaped article, of this composition.

### DETAILS OF THE INVENTION

Herein certain terms are used, and they are defined below:

By a “thermoplastic” is meant a polymer, preferably having a weight average molecular weight of about 10,000 or more, more preferably about 20,000 or more, and which has a glass transition temperature and/or at least one melting point above 30° C., more preferably above about 50° C. and especially preferably above about 100° C. Preferably at least one of these melting points (if there is more than one) has a heat of fusion associated with it of 3 J/g or more, preferably at least about 5 J/g or more. Melting points, heats of fusion, and glass transition temperatures are measured by ASTM Method D3418, at a heating rate of 10° C./minute, using measurements on the second heat. The melting point is taken as the peak of the endotherm. The glass transition point is taken as the midpoint (inflection point) of the transition. Thus thermoplastics may include both semicrystalline and amorphous polymers.

By a “partially aromatic polyamide” is meant a polyamide or blend of polyamides in which at least 5 mole percent of all repeat units in the polyamide or blend of polyamides have an aromatic ring, which means thermoplastic polyamides having all repeat units containing an aromatic ring may be used. However, preferably no more than 60 mole percent of the repeat units have an aromatic ring. By an aromatic ring is meant a group such as phenyl or phenylene, naphthyl or naphthylylene, biphenyl or biphenylene, or pyridyl or pyridylylene. Preferably the aromatic ring is in the main chain of the polymer, i.e., is not a “side group” in the repeat unit. Units in the main chain would include those derived from terephthalic acid, isophthalic acid, 2,6-naphthalene dicarboxylic acid, 1,4-diaminobenzene, 1,3-diaminobenzene, 1,4-bis(aminomethyl)benzene, 1,3-bis(aminomethyl)benzene, 4,4′diaminobiphenyl, 4-aminobenzoic acid, and 3-aminobenzoic acid. Repeat units with aromatic side groups include those derived from 3-phenyl-1,6-diaminohexane and 2-(4-pyridyl)succinic acid. If more than one polyamide is present (a blend of polyamides) then all repeat units in all polyamides are used in this calculation, whether any particular polyamide has any repeat units containing aromatic groups or not.

By a “polyamide” is meant a polymer in which at least 90 mole percent of the groups linking the monomers together are amide groups, preferably at least 98%.

By a “chopped” fiber is meant a fiber whose number average length is about 5 cm or less, preferably about 2.5 cm or less, more preferably about 1.3 cm or less, and especially preferably less than about 0.6 cm, when measured on the final composition, or in the case of a shaped article, the shaped article. Fiber lengths may be measured by standard optical or electron microscopy methods (as appropriate, depending on the diameter of the fiber, the magnification required is such that at least 90% of the fibers are visible at that magnification).

Glass fibers typically used as fillers/reinforcing agents for thermoplastics may be used, and preferably the glass fiber has a diameter of about 30 μm or less, more preferably about 20 μm or less, and especially preferably have a diameter of about 5 to about 13 μm. The glass fiber may be sized or unsized, but it is preferred that the glass fiber be sized, especially with a sizing, as now commercially available, designed for the particular thermoplastic(s) being used. Preferably the glass fiber has a tensile modulus of about 30 GPa or more.

Carbon fibers typically used as fillers/reinforcing agents for thermoplastics may be used, and preferably the carbon fiber has a diameter of about 20 μm or less, more preferably about 10 μm or less. The carbon fiber may be sized or unsized, but it is preferred that the carbon fiber be sized, especially with a sizing, as now commercially available, designed for the particular thermoplastic(s) being used. The carbon fiber may be made in a number of ways, for instance it may be “pitch based” or made from polyacrylonitrile. Preferably the carbon fiber has a tensile modulus of about 150 GPa or more.

Preferably the minimum amount of fiber component (glass fiber plus carbon fiber) is about 52 weight percent, more preferably about 55 weight percent, while the maximum amount of fiber component is 70 weight percent, more preferably about 65 weight percent, and especially preferably about 62 weight percent. It is to be understood that any maximum amount of fiber component can be combined with any minimum amount of fiber component to form a preferred fiber component range.

Herein the ratio of glass fiber to carbon fiber (glass:carbon) ranges from a maximum of about 13:1.0 to a minimum of about 1.0:1.0 Preferably the maximum is about 8:1.0, more preferably 6:1.0, and preferably the minimum is about 2.0:1.0, more preferably 3.0:1.0. It is to be understood that any such maximum amount may be combined with any such minimum amount to form a preferred ratio range.

Virtually any kind of thermoplastic may be used, including poly(oxymethylene) and its copolymers; polyesters such as PET, poly(1,4-butylene terephthalate), poly(1,4-cyclohexyldimethylene terephthalate), and poly(1,3-poropyleneterephthalate); polyamides such as nylon-6,6, nylon-6, nylon-12, nylon-11, and partially aromatic (co)polyamides; polyolefins such as polyethylene (i.e. all forms such as low density, linear low density, high density, etc.), polypropylene, polystyrene, polystyrene/poly(phenylene oxide) blends, polycarbonates such as poly(bisphenol-A carbonate); fluoropolymers including perfluoropolymers and partially fluorinated polymers such as copolymers of tetrafluoroethylene and hexafluoropropylene, poly(vinyl fluoride), and the copolymers of ethylene and vinylidene fluoride or vinyl fluoride; polysulfones such as poly(p-phenylene sulfone), polysulfides such as poly(p-phenylene sulfide); polyetherketones such as poly(ether-ketones), poly(ether-ether-ketones), and poly(ether-ketone-ketones); poly(etherimides); acrylonitrile-1,3-butadinene-styrene copolymers; thermoplastic (meth)acrylic polymers such as poly(methyl methacrylate); and chlorinated polymers such as poly(vinyl chloride), vinyl chloride copolymer, and poly(vinylidene chloride). Also included are thermpoplastic elastomers such as thermoplastic polyurethanes, block-copolyesters containing so-called soft blocks such as polyethers and hard crystalline blocks, and block copolymers such as styrene-butadiene-styrene and styrene-ethylene/butadiene-styrene block copolymers. Polymers which may be formed in situ, such as (meth)acrylate ester polymers are also included. Also included herein are blends of thermoplastic polymers, including blends of two or more semicrystalline or amorphous polymers, or blends containing both semicrystalline and amorphous thermoplastics.

Preferred types of thermoplastics include polyamides, especially partially aromatic polyamides, polyesters, poly(etherimides), and polysulfones. Another preferred type of thermoplastic is a semicrystalline thermoplastic, that is thermoplastics with melting points as described above.

These compositions may contain other materials that are conventionally found in thermoplastic compositions other than those described in the claims. For instance these may include other fillers/reinforcing agents, stabilizers, mold releases or lubricants, antioxidants, tougheners, other types of polymers, crystallization promoters, flame retardants, and antistatic agent(s). If other polymeric materials are present is the composition the percentage of the filler component is based on the total weight of all polymers present plus the weight of the filler component.

By a toughener is meant a polymeric material which typically is an elastomer or has rubbery characteristics. It may be a thermoplastic as defined herein, but it will often have a high elongation to break. The toughener may or may not contain functional groups which react with the “matrix” resin. Typical tougheners are EP rubber, EPDM rubber grafted with maleic anhydride, sytrenic block copolymers, and copolymers of ethylene and various acrylic esters. Some of these acrylic esters may contain reactive functional groups such as epoxy. Such tougheners are well known in the art, see for instance C. R. Bucknall, Toughened Plastics, Applied Science Publishers, Ltd., London, 1977, and E. A. Flexman Toughened Semicrystalline Engineering Polymer: Morphology, Impact Resistance and Fracture Mechanisms in C. K. Riew, et al., Ed., Advances in Chemistry Series 233, Toughened Plastics I, American Chemical Society, Washington D.C., 1993.

Preferably the present compositions have a tensile modulus of 25 GPa or more when measured by ASTM Method D638, at an extension rate of 5.8 mm/min (0.20″/min), using a Type IV bar, and/or a notched Izod of about 80 Nm/m (1.5 ft.lb./in) or more when measured by ASTM Method D256, more preferably 107 Nm/m (2.0 ft.lb./in.) or more. Both measurements are preferably made on specimens 0.32 cm (⅛ in.) thick.

The present compositions may be made by methods well known in the art for making thermoplastic compositions with fillers/reinforcing agents (and optionally other materials) present. The polymer may be melt mixed with the carbon and glass fibers in typical melt mixing equipment such as single or twin screw extruders, kneaders, and other similar devices. In melt mixing the thermoplastic is heated above its melting point to mix in the various ingredients, including the glass and carbon fiber. While it is preferred that both of these fibers be added in their chopped form this is not necessary since normally such mixers will cut the fibers to the desired length anyway. In order to preserve the fiber lengths, it may be desirable to “side feed” the chopped fiber(s) in order to minimize shear degradation of the fiber lengths. Other than side feeding, no particular order of adding the ingredients is preferred. Alternatively the glass and/or carbon fiber may be added during the synthesis of the thermoplastic and dispersed during that process. No matter what process is used, in the resulting composition, as is well known in the art for all similar thermoplastic compositions, the ingredients should preferably be well dispersed.

The compositions may also be made by making “masterbatches” containing glass fiber and/or carbon fiber and blending pellets of the proper concentrations of these fillers with other pellets containing no or lesser amounts of these fibers in order to form the desired composition in a melt mixer such as an extruder. This is sometimes called cube blending.

The composition may be formed into shaped articles by many processes known in the art in general for forming thermoplastic parts. By a shaped article is meant a part with one, two or three definite, and normally desired dimensions, and includes films, sheets, two dimensional extrusions, and three dimensional parts. The parts may be formed by heating the composition to either soften (but not melt) it or heated above the melting point to melt it. Whether softened or melted the composition is then “forced” into or through some sort of mold or die that shapes the composition. Processes that require melting include injection molding, melt extrusion, and blow molding. A process that requires softening is thermoforming. Processes that require one or both of melting and softening include rotomolding, and compression molding. All of these processes are well known in the art. Preferred forming processes are injection molding, extrusion, and compression molding, and injection molding is especially preferred.

The present compositions are especially useful as shaped parts wherein high stiffness and tensile strength are needed, especially in combination with some toughness.

In the Examples tensile properties were determined using ASTM Method D638, using a Type IV bar and an extension rate of 5.08 mm/min (0.20″), and notched Izod was measured by ASTM Method D256. All test pieces were 0.32 cm (⅛″) thick. Elongation is percent tensile elongation to break. In the Examples, unless otherwise noted, all parts are parts by weight.

In the Examples certain ingredients are used. They are:
Acrawax® C is manufactured by Lonza Group Ltd., CH-4003 Basel, Switzerland.
ChopVantage® 3540 is a chopped glass fiber (nominal length 3.2 mm) available from PPG Industries, Pittsburgh, Pa. 15272, USA.
ChopVantage® 3660 is a chopped glass fiber (nominal length 3.2 mm) available from PPG Industries, Pittsburgh, Pa. 15272, USA.
Crystar® 3934 is a poly(ethylene terephthalate) polymer with an intrinsic viscosity of 0.58-0.67, manufactured by E. I DuPont de Nemours & Co., Inc., Wilmington, Del. 19898, USA.
Epon® 1009 is an epoxy thermoset resin available from Hexion Specialty Chemicals, Columbus, Ohio 43215, USA.
Fortal 201 is a chopped carbon fiber (nominal length 0.64 cm) made by Toho Tenax America, Inc., Rockwood, Tenn. 37854, USA.
Irganox® 1010—antioxidant available from Ciba Specialty Chemicals, Tarrytown, N.Y., USA.
Licomont® CaV 102 fine grain is a calcium salt of montanic acid available from Clariant Corp., 4132 Mattenz, Switzerland.
Licowax® OP is a partially soaponified ester wax manufactured by Claniant Corp., Charlotte, N.C. 28205, USA.
M 10-52 Talc is manufactured by Barretts Minerals, Inc., Dillon, Mont., USA.
Panex® 33 is chopped carbon fiber (nominally 0.8 cm long) manufactured by Zoltek Corp., Bridgeton, Mo. 63304, USA.
Plasthall® 809—polyethylene glycol 400 di-2-ethylhexanoate, available from Ester Solutions, Bedford Park, Ill. 60499, USA.
Polymer A is a copolyamide made from terephthalic acid, 1,6-hexanediamine and 2-methyl-1,5-pentanedaimine, with a molar ratio of 1,6-hexanediamine:2-methyl-1,5-pentanediamine of 1:1.
Polymer B is a copolymer 1,6-hexanediamine, terephthalic acid and adipic acid, with a molar ratio of terephthalic acid:adipic acid of 55:45.
Polymer D is an amorphous copolyamide of 1,6-hexanediamine, terephthalic acid and isophthalic acid, with a terephthalic acid:isophthalic acid molar ratio of 3:7.
Polymer E is Makrolon® 2458, an amorphous polycarbonate polymer made by Bayer Material Science AG, D-51368, Leverkusen, Germany.
Polymer F is believed to act as a toughener and is an EPDM rubber grafted with 1.8 weight percent maleic anhydride.
Polymer G is Engage® 8180, an ethylene-octene copolymer elastomer available from Dow Chemical Co., Midland, Mich. 48674 USA.
PPG 3563 is a chopped fiberglass (nominal length 3.2 mm) available from PPG Industries, Pittsburgh, Pa. 15272, USA.
PPG 3660 is a chopped fiberglass (nominal length 3.2 mm) available from PPG Industries, Pittsburgh, Pa. 15272, USA.
Sigrafil® C25 S006 APS is chopped (nominal length 6 mm) manufactured by SGL Carbon Gmbh, 86405 Meitingen, Germany.
Surlyn® 8920 is an ethylene copolymer ionomer manufactured by E. I DuPont de Nemours & Co., Inc., Wilmington, Del. 19898, USA.
Ultranox® 626A—an antioxidant, bis(2,4-di-t-butylphenyl)pentaerythritol diphosphite, available from GE Specialty Chemicals, Inc., Morgantown, W. Va. 26501 USA.
Zytel® 101 is a nylon-6,6 (polyamide) resin available from E. I DuPont de Nemours & Co., Inc., Wilmington, Del. 19898, USA.

### EXAMPLES 1-4 AND COMPARATIVE EXAMPLES A-D

The compositions were made by mixing in a Werner & Pfleiderer 30 mm twin screw extruder at a nominal rate of about 13.6 kg/h at barrel temperatures of 290-340° C. depending on the partially aromatic polyamide used. The extruder had one feeder at the rear for all of the ingredients except the carbon and glass fibers, each of which was separately side fed through a feeder. They were molded into 0.32 cm thick standard ASTM test specimens on a 6 oz. Model 200 HPM Injection Molding Machine. Compositions and physical properties are given in Table 1.

TABLE 1

| | Example | | | | | | | |
|---|---|---|---|---|---|---|---|---|
| | A | B | 1 | 2 | 3 | C | D | 4 |
| Polymer A | 69.25 | 59.00 | 39.00 | 39.00 | 39.00 | 39.00 | 49.25 | |
| Polymer B | | | | | | | | 39.35 |
| Sigrafil ® C25 S006 APS | 30.00 | 40.00 | 20.00 | 15.00 | 10.00 | 0.00 | 0.00 | 15.00 |
| ChopVantage ® 3540 | 0.00 | 0.00 | 40.00 | 45.00 | 50.00 | 60.00 | 50.00 | 45.00 |
| Stabilizers | 0.50 | 0.40 | 0.40 | 0.40 | 0.40 | 0.40 | 0.40 | 0.40 |
| Licowax ® OP | 0.25 | 0.25 | 0.25 | 0.25 | 0.25 | 0.25 | 0.00 | 0.25 |
| M10-52 talc | 0.00 | 0.35 | 0.35 | 0.35 | 0.35 | 0.35 | 0.35 | 0.00 |
| Tensile Strength (MPa) | 258.0 | 259.8 | 234.9 | 238.5 | 237.0 | 240.0 | 270.0 | 198.0 |
| Tensile Modulus (GPa) | 23.0 | 29.9 | 31.7 | 29.4 | 27.1 | 22.6 | 17.4 | 32.2 |
| Tensile Elongation, % | 1.5 | 1.2 | 1.0 | 1.1 | 1.2 | 1.5 | 2.3 | 0.8 |
| Notched Izod, Nm | 62.0 | 66.8 | 90.6 | 104 | 104 | 124 | 143 | 105 |

### EXAMPLE 5 AND COMPARATIVE EXAMPLES E-G

The compositions were made by mixing in a Werner & Pfleiderer 30 mm twin screw extruder at a nominal rate of about 13.6 kg/h at barrel temperatures of 290-340° C. depending on the partially aromatic polyamide used. The extruder had one feeder at the rear for all of the ingredients except the carbon and glass fibers, each of which was separately side fed through a feeder. They were molded into 0.32 cm thick standard ASTM test specimens on a 6 oz. Model 200 HPM Injection Molding Machine. Compositions and physical properties are given in Table 2.

TABLE 2

| | Example | | | |
|---|---|---|---|---|
| | E | F | 5 | G |
| Zytel ® 101 | 41.50 | 34.50 | 27.35 | 27.35 |
| Polymer D | 17.80 | 14.80 | 12.00 | 12.00 |
| PPG3660 | 0.00 | 0.00 | 45.00 | 60.00 |
| Panex ® 33/48 | 40.00 | 50.00 | 15.00 | 0.00 |
| Stabilizer | 0.40 | 0.40 | 0.40 | 0.40 |
| Acrawax ® C | 0.25 | 0.25 | 0.25 | 0.25 |
| Tensile Strength (MPa) | 258.0 | 252.0 | 259.0 | 248.0 |
| Tensile Modulus (GPa) | 28.7 | 35.5 | 26.1 | 20.3 |
| Tensile Elongation, % | 1.6 | 1.2 | 1.8 | 2.3 |
| Notched Izod, Nm | 71.6 | .66.8 | 124 | 167 |

### EXAMPLE 6 AND COMPARATIVE EXAMPLES H-J

The compositions were made by mixing in a Werner & Pfleiderer 30 mm twin screw extruder at a nominal rate of about 13.6 kg/h at barrel temperatures of 280-290° C. The extruder had one feeder at the rear for all of the ingredients except the carbon and glass fibers, each of which was separately side fed through a feeder. They were molded into 0.32 cm thick standard ASTM test specimens on a 6 oz. Model 200 HPM Injection Molding Machine. Compositions and physical properties are given in Table 3.

TABLE 3

| | Example | | | |
|---|---|---|---|---|
| | H | I | J | 6 |
| Panex ® 33 | | | 39.5 | 15 |
| Crystar ® 3934 | 40 | 35 | 55 | 35 |
| PPG 3563 | 54.5 | 59.5 | | 44.5 |
| Ultranox ® 626A | 0.13 | 0.13 | 0.13 | 0.13 |
| Surlyn ® 8920 | 2.49 | 2.49 | 2.49 | 2.49 |
| Plasthall ® 809 | 1.9 | 1.9 | 1.9 | 1.9 |
| Irganox ® 1010 | 0.1 | 0.1 | 0.1 | 0.1 |
| Epon ® 1009 | 0.9 | 0.9 | 0.9 | 0.9 |
| Tensile Strength, MPa | 198 | 190 | 194 | 177 |
| Tensile Modulus, GPa | 21.45 | 23.13 | 24.94 | 28.36 |
| Tensile Elongation, % | 1.71 | 1.43 | 1.56 | 1.21 |
| Notched Izod, Nm/m | 141 | 135 | 49.7 | 83.8 |

### EXAMPLES 7-8 AND COMPARATIVE EXAMPLE K-L

The compositions were made by mixing in a Werner & Pfleiderer 30 mm twin screw extruder at a nominal rate of about 13.6 kg/h at barrel temperatures of 280-290° C. The extruder had one feeder at the rear for all of the ingredients except the carbon and glass fibers, each of which was separately side fed through a feeder. They were molded into 0.32 cm thick standard ASTM test specimens on a 6 oz. Model 200 HPM Injection Molding Machine. Compositions and physical properties are given in Table 4.

TABLE 4

| | Example | | | |
|---|---|---|---|---|
| | K | L | 7 | 8 |
| Zytel ® 101 | 39.35 | 59.35 | 59.35 | 49.35 |
| ChopVantage ® 3660 | 60 | 0 | 45 | 30 |
| Panex ® 33 | 0 | 40 | 15 | 20 |
| Stabilizer | 0.4 | 0.4 | 0.4 | 0.4 |
| Acrawax ® C | 0.25 | 0.25 | 0.25 | 0.25 |
| Tensile Strength (MPa) | 265 | 251 | 259 | 247 |
| Tensile Modulus (GPa) | 21.86 | 29.50 | 27.56 | 25.10 |
| Tensile Elongation (%) | 2.20 | 1.36 | 1.93 | 1.93 |
| Notched Izod, Nm/m | 200 | 81.1 | 143 | 110 |

### EXAMPLES 9-10 AND COMPARATIVE EXAMPLES M-O

The compositions were made by mixing in a Werner & Pfleiderer 30 mm twin screw extruder at a nominal rate of about 13.6 kg/h at barrel temperatures of 280-290° C. The extruder had one feeder at the rear for all of the ingredients except the carbon and glass fibers, each of which was separately side fed through a feeder. They were molded into 0.32 cm thick standard ASTM test specimens on a 6 oz. Model 200 HPM Injection Molding Machine. Compositions and physical properties are given in Table 5.

TABLE 5

| | Example | | | | |
|---|---|---|---|---|---|
| | M | 9 | 10 | N | O |
| Polymer D | 59.35 | 40 | 40 | 50 | 40 |
| PPG3660 | | 44.35 | 39.35 | 49.35 | 59.35 |
| Panex ® 33 | 40 | 15 | 20 | 0 | 0 |
| Stabilizer | 0.4 | 0.4 | 0.4 | 0.4 | 0.4 |
| Acrawax ® C | 0.25 | 0.25 | 0.25 | 0.25 | 0.25 |
| Tensile Strength (MPa) | 240 | 253 | 243 | 262 | 270 |
| Tensile Modulus (GPa) | 25.60 | 27.63 | 28.70 | 17.21 | 22.29 |
| Tensile Elongation (%) | 1.37 | 1.5 | 1.36 | 2.72 | 1.99 |
| Notched Izod Nm/m | 52.5 | 105 | 100 | 167 | 172 |

### EXAMPLE 11 AND COMPARATIVE EXAMPLES P-R

The compositions were made by the same method used to make the compositions of Examples 9-10 and Comparative Examples M-O, except Polymer E was used instead of Polymer D. Compositions and properties are shown in Table 6.

TABLE 6

| | Example | | | |
|---|---|---|---|---|
| | P | Q | R | 11 |
| Polymer E | 49.75 | 39.75 | 59.75 | 39.75 |
| Chopvantage ® 3563 | 50 | 60.00 | 39.35 | 45 |
| Acrawax ® C | 0.25 | 0.25 | 0.25 | 0.25 |
| Fortafil ® 201 | 0 | 0 | 40 | 15 |
| Tensile Strength (MPa) | 144 | 154 | 140 | 140 |
| Tensile Modulus (GPa) | 15.99 | 21.45 | 22.1 | 24.7 |
| Tensile Elongation (%) | 1.6 | 1.5 | 1.4 | 1.2 |
| Notched Izod (Nm) | 156 | 146 | 50.7 | 109 |

### EXAMPLE 12

Using the same procedure as used for Example 5 and Comparative Examples E-G, the a composition was prepared and test pieces made. The composition and physical properties are shown in Table 7.

TABLE 7

| | Example |
|---|---|
| | 12 |
| nylon-6,6 | 19.85 |
| Polymer D | 8.51 |
| Polymer F | 2.58 |
| Polymer G | 3.42 |
| stabilizer | 0.40 |
| Licomont ® CaV 102 fine grain | 0.25 |
| Panex ® 33 | 15.00 |
| PPG ® 3660 | 50.00 |
| Tensile Strength (MPa) | 205 |
| Tensile Modulus (GPa) | 25.7 |
| Tensile elongation % | 1.93 |
| Notched Izod (Nm/m) | 142 |

The results in the Tables show that high modulus with relatively good toughness (Notched Izod test, the higher the value the tougher the composition) can be achieved with the composition of the present invention. This combination of properties wasn't achieved by glass or carbon fibers alone.

What is claimed is:

1. A composition, comprising,
(a) a thermoplastic; and
(b) a filler component consisting essentially of chopped glass fiber and chopped carbon fiber wherein said filler component is more than 50 weight percent of the total weight of said composition, and a weight ratio of said glass fiber to said carbon fiber is about 13:1.0 to about 1.0:1.0.

2. The composition as recited in claim 1 wherein said thermoplastic has a melting point and/or glass transition temperature of about 100° C. or more.

3. The composition as recited in claim 1 wherein said thermoplastic is one or more of a poly(oxymethylene) or a copolymer thereof, a polyester, a polyamide, a polycarbonate, a polyolefin, a fluoropolymer, a polysulfone, a polysulfide, a polyetherketone, a poly(etherimide), an acrylonitrile-1,3-butadiene-styrene copolymer, a thermoplastic (meth)acrylic polymer, or a chlorinated polymer.

4. The composition as recited in claim 1 wherein said filler component is about 55 weight percent or more of said composition.

5. The composition as recited in claim 1 wherein a weight ratio of said glass fiber to said carbon fiber is about 8:1.0 to about 2.0:1.0.

6. The composition as recited in claim 1 wherein said thermoplastic is semicrystalline.

7. The composition as recited in claim 1 wherein said thermoplastic is a partially aromatic polyamide.

8. The composition as recited in claim 1 which has tensile modulus of 25 GPa or more and a Notched Izod of 80 Nm/m or more.

9. The composition of claim 1 additionally comprising a toughener.

10. A shaped part of the composition of claim 1.
